(19) United States
(12) Patent Application Publication
(10) Pub. No.: US 2024/0056655 A1
(43) Pub. Date: Feb. 15, 2024

(54) Visible Background Rejection Techniques for Shared-Camera Hardware

(71) Applicant: Ultraleap Limited, Bristol (GB)

(72) Inventors: Ryan Frank Page, Saltford (GB); Paolo Giuseppe Baesso, Bristol (GB); Mark Chatterton, Bristol (GB); Ollie Powell, Bristol (GB); John Selstad, Mountain View, CA (US)

(21) Appl. No.: 18/447,132

(22) Filed: Aug. 9, 2023

Related U.S. Application Data
(60) Provisional application No. 63/371,187, filed on Aug. 11, 2022.

(51) Int. Cl. H04N 23/11; G06T 5/50; G06T 7/194; G06T 7/20; G06T 7/579; G06V 40/20

(52) U.S. Cl. CPC H04N 23/11; G06T 5/50; G06T 7/194; G06T 7/20; G06T 7/579; G06V 40/28; G06T 2207/10048; G06T 2207/20224

(57) ABSTRACT

Techniques are required that compensate for the presence of unwanted background in IR images. This is achieved by operating the imaging system such that it captures alternating frames of visible and IR. The IR frames will contain visible background, which needs to be removed by way of subtraction or active selection of only the IR band. In one solution, the background may be estimated based on the visible image and subtracted to give a reconstructed IR frame. In another solution, an optical shutter is positioned in front of the sensor. This optical shutter is shut when the IR illumination is active to block the visible band, thereby producing images on par with those using IR bandpass filters. Then the optical shutter is open during ambient exposures, thereby generating images that can be used by tracking modalities that require visible frames such as head-tracking using SLAM.

### PRIOR APPLICATIONS

This application claims the benefit of the following application, which is incorporated by references in its entirety:

U.S. Provisional Patent Application No. 63/371,187, filed on Aug. 11, 2022.

### FIELD OF THE DISCLOSURE

The present disclosure relates generally to improved techniques in processing visible backgrounds.

### BACKGROUND

In extended reality (XR) it is often necessary to have multiple active tracking systems on the same device, with some tracking systems relying on ambient light and some on infrared (IR) illumination (i.e., IR light produced by dedicated light-emitting diodes (LEDs) or vertical-cavity surface-emitting laser (VCSELs), synchronized with the image frame capture). This results in a proliferation of image sensors that may have identical underlying hardware but differ in the filter used to select the spectrum of sensitivity. The current trend for XR devices is to adopt multiple sensors, tuned for the part of spectrum of interest (visible, IR). This increases costs and hardware complexity.

In a system where each tracking application requires either visible or IR images, the imaging devices need to employ some time slicing switching between sampling first for one spectrum then another. For IR-based tracking systems, visible light constitutes an unwanted background that needs to be removed either by means of optical filters or image processing.

This disclosure describes methods to account for that visible-light background in IR frames.

One possible solution involves placing a filter in front of the sensor using a mechanical shutter. But this becomes unpractical at high frame rates (>100 Hz) due to the inertia of moving elements. The noise introduced by the mechanical switch and the size of the parts also make this solution undesirable for headset devices.

One paper from the search “liquid crystal shutters to separate ambient and infrared” is C. S. Lee, “An electrically switchable visible to infra-red dual frequency cholesteric liquid crystal light shutter,” Journal of Materials Chemistry C 6, 4243 (2018). Lee switches between a long and short bandpass filter, which differs from what is described herein.

The proposed solutions do not use mechanical parts. Instead, they rely on post-processing the image feeds or using optical shutters based on optoelectronic parts capable of fast switching speeds.

One solution employs a software based approach where information from the visible exposure taken prior to the IR exposure is used to remove the ambient visible light in the IR frame. This can be taken a step further by employing an optical shutter to actively select what wavelength reaches the sensor, requiring little to no image processing.

Another approach adopts a tunable bandpass filter, as used in multispectral imaging.

Custom filter patterns may also be used utilizing the subtraction method. Spatial resolution may be sacrificed in this method.

### SUMMARY

It would be advantageous to be able to use the same hardware to accomplish different tracking tasks in XR. Typically these tasks use different wavelengths. For example, state-of-the-art head-tracking uses simultaneous localization and mapping (SLAM) that depends on ambient visible light, while hand and controller tracking use active IR. To achieve this, technology and techniques are required that compensate for the presence of unwanted background in IR images. This is achieved by operating the imaging system such that it captures alternating frames of visible and IR. The IR frames will contain visible background, which needs to be removed by way of subtraction or active selection of only the IR band. In one solution, the background may be estimated based on the visible image and subtracted to give a reconstructed IR frame. In another solution, an optical shutter is positioned in front of the sensor. This optical shutter is shut when the IR illumination is active to block the visible band, thereby producing images on par with those using IR bandpass filters. Then the optical shutter is open during ambient exposures, thereby generating images that can be used by tracking modalities that require visible frames such as head-tracking using SLAM.

### BRIEF DESCRIPTION OF THE DRAWINGS

The accompanying figures, where like reference numerals refer to identical or functionally similar elements throughout the separate views, together with the detailed description below, are incorporated in and form part of the specification, serve to further illustrate embodiments of concepts that include the claimed invention and explain various principles and advantages of those embodiments.

FIGS. 1A, 1B, 1C, 1D, 1E, and 1F show examples of image-processed background subtraction.

FIGS. 2A and 2B show diagrams of positions of a liquid crystal (LC) shutter in front of camera.

FIG. 3 shows an optimization that integrates the LC shutter into a camera module.

FIG. 4 shows a curve of LC transmittance at various wavelengths.

FIG. 5 shows a curve of visible light transmission versus bias voltage applied.

FIG. 6 shows a timing diagram of signals used to trigger the opening/closing of a LC shutter with respect to a camera strobe signal.

FIGS. 7A, 7B, 7C, and 7D show images obtained with an exemplary system.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

XR devices need to run multiple tracking systems to create fully immersive experiences. The key external sensing systems on these devices are head, hand, and controller tracking. The move towards wireless devices puts constraints on power, which creates a strong drive to share hardware resource across tracking modalities. The state-of-the-art head tracking uses SLAM techniques with mono wide angle visible cameras. These cameras feature a dual band pass filter with pass bands in the visible spectrum (400-650 nm) and near-infrared (NIR) spectrum (850 nm). The sensor itself is broadband and is sensitive to both ranges (although with different efficiencies depending on the sensing technology, i.e., Si vs InGaAs). Thus, any background light source in this band will result in a signal in the sensor. SLAM is only one example of computer vision techniques; other computer vision techniques may be used herein.

Capturing a scene in the visible spectrum is straightforward: the capture needs to be synchronized with any IR sources such that the IR sources are not active. The camera's sensitivity to IR is not a problem as ambient background IR is typically low.

Cameras used in hand-tracking have the same characteristics, except that state-of-the-art hand tracking uses IR illumination (i.e., IR light produced by dedicated LEDs or VCSELs, synchronized with the image frame capture) and feature an IR bandpass filter. In the case where IR frames are generated on a camera used for SLAM only, the IR is desired and additional techniques to filter out ambient visible light are required as the visible light in scene cannot be simply switched off. Solving this problem requires an IR illumination imaging technique that can suppress the background coming from the visible light in the scene.

One obvious option to allow both steps to share the same hardware and run hand-tracking on visible light frames. But this would degrade the performance considerably. Active IR is used over visible for hand-tracking because: i) it enables robust tracking across a wide range of ambient lighting conditions; ii) it maintains performance in complex scenes where the background is feature rich; and iii) it ensures the system is agnostic to skin pigment and clothing.

This disclosure solves the above issues by optimizing the sensor for the IR band by changing the exposure and gain and removing the visible background by estimating visible background using the same sensor variables. This can then be subtracted to create a reconstructed IR image of the scene. Performance may be further increased using a fast optical shutter that is closed for IR exposures. This ensures the sensor is only exposed to IR (thus generating optimal images in that band) and open for visible captures to allow a scene to be imaged optimally in the visible band.

In one embodiment of this disclosure, consider a sensor that is sensitive to both visible and IR that is used to capture an image of a scene using both parts of the spectrum. This requires a sensor that can switch between settings optimized for visible and IR. The ability to do this is available in most sensors and is referred to as “context switching”.

In the following example, frames are being generated for the computer vision and hand-tracking applications. The first context (context 1) contains settings for computer vision and the second context (context 2) is for hand-tracking. In this case the context 1 contains sensor settings to ensure a balanced image using visible light, optimized by an Auto Exposure (AE). Context 2 contains sensor settings that are controlled by the hand-tracking AE. To ensure the experience is not affected by hardware sharing, the frame rate of the sensor needs to be twice that of the typical individual case. A suitable rate is 60 fps for each application, which leads to a sensor readout of 120 fps.

During context 2, the IR illumination is active and is synchronized to the exposure of the sensor. This minimizes the amount of visible background. The IR illumination may be pulsed or strobed. The reminding visible background can be reconstructed using the previous image produced using the settings from context 1 and subtracted from image generated with IR using the settings in context 2. This subtraction-based method relies on knowing the settings used for each exposure. The following parameters are needed in the instance where the AE changes only the exposure and gain of sensor:
1. Gain for NIR frame (G₀);
2. Gain for ambient frame (G₁);
3. Exposure for NIR frame (E₀);
4. Exposure for ambient frame (E₁); and
5. Black level setpoint (this is an offset applied in sensor) (α).

The signal in one frame based on another where the input light is constant may be computed using the following:

$$\begin{matrix}{S}_{0} = {G}_{0} {E}_{0} K + α \\ {S}_{1} = {G}_{1} {E}_{1} K + α \\ {S}_{0} = \frac{{G}_{0} {E}_{0}}{{G}_{1} {E}_{1}} ( {S}_{1} - α ) + α\end{matrix}$$

where S₀ is the signal level for image settings; G₀, E₀, K, and α correspond to gain, exposure, common sensor parameters, and black level respectively; and S₁ is the signal level for image settings G₁, E₁, K, and α.

Taking the ratio allows S₀ to be determined from S₁ and the corresponding sensor parameters. Letting S₁ be the visible frame, S₀ is then the calculated ambient signal in the NIR frame which leads to:

S_{NIR}=S_{NIR+Amb}−S_{Amb}

where S_{NIR} is the signal from just NIR; S_{NIR+Amb} is sum of the signal from NIR and ambient; and S_{Amb} is the ambient light determined from the ambient only frame of the previous capture. Taking the example G₀=G₁, E₀=E₁, this results in the direct subtraction of the previous frame with no NIR from the new frame with NIR plus ambient.

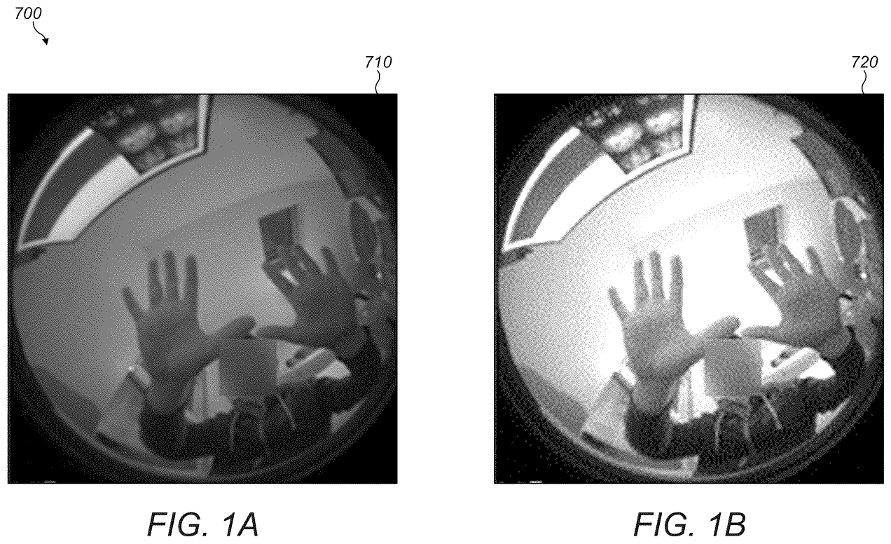

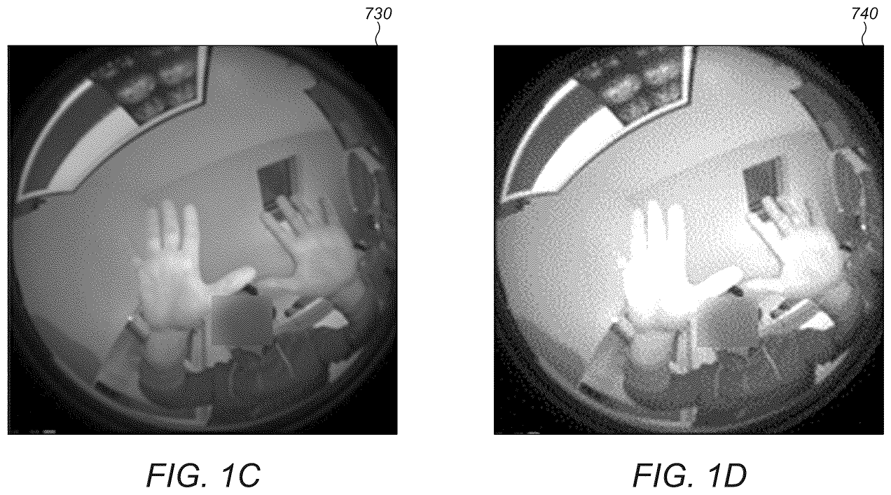

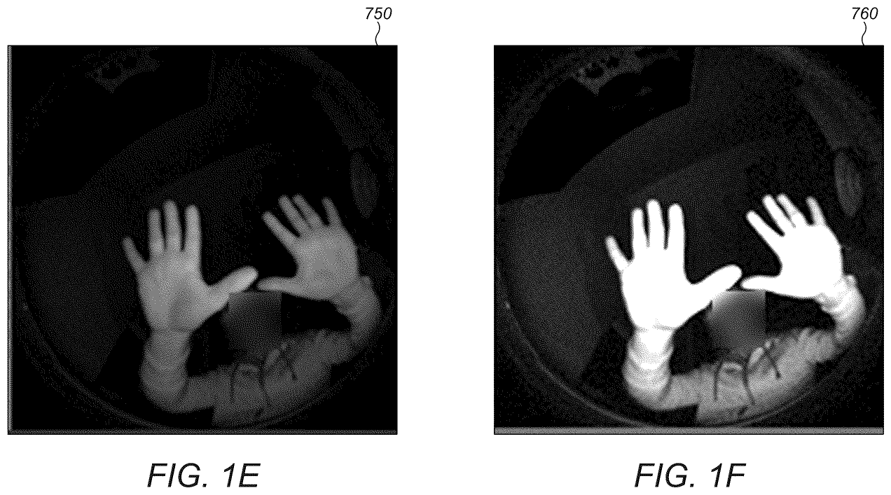

Turning to FIGS. 1A through 1F, shown is a sequence 700 of images illustrating the efficacy of the foregoing (faces are blurred for privacy). FIG. 1A shows an image 710 of ambient illumination. FIG. 1B shows an image 720 that is a high-contrast version of FIG. 1A. FIG. 1C shows an image 730 of IR illumination of the same view as FIG. 1A. FIG. 1D shows an image 740 of a high-contrast version of FIG. 1C. FIG. 1E shows a background-subtracted image 750 of the same view of FIG. 1A. FIG. 1F shows an image 760 of a high-contrast version of FIG. 1E. As can be seen by inspection, FIGS. 1E and 1F show images with the foreground (hands) clearly visible and having little background detail.

This technique works better in the situation where motion is small between sample times. Otherwise, artifacts from motion may occur. This can be minimized by interpolating two visible captures to get a better prediction of the background. For example, if at t=0 a visible capture is taken, at t=1 an IR capture is made, and t=3 another visible capture is taken, a visible frame may be generated by interpolating between t=0 and t=3. This frame may then be used in the estimate of the visible background in frame t=1.

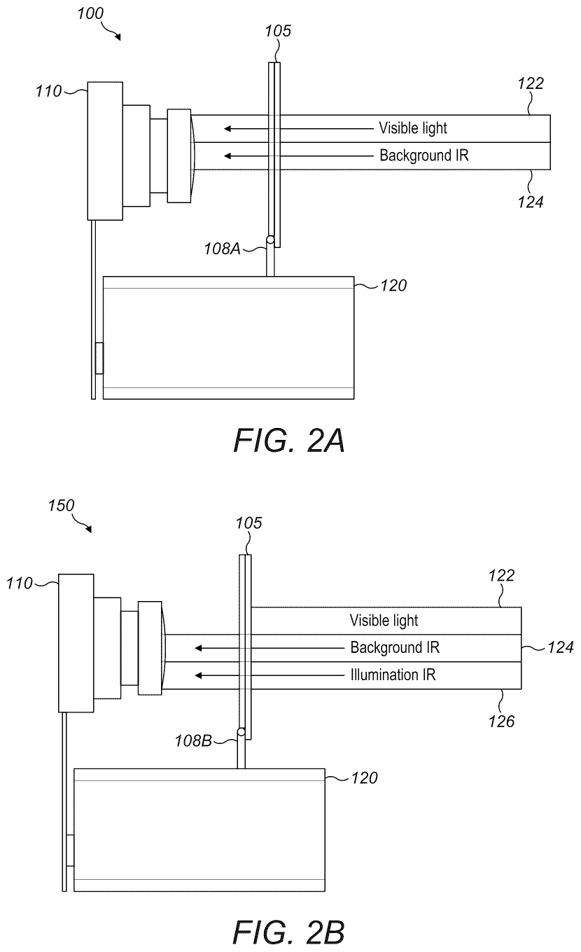

Turning to FIG. 2A, shown is a schematic 100 of a camera module 110 connected to a synchronization circuit 120 having an optical shutter 105 with the shutter open 108A. This allows visible light 122 and background IR 124 to reach the camera module. Turning to FIG. 2B, shown is a schematic 150 of a camera module 110 connected to a synchronization circuit 120 having an optical shutter 105 with the shutter closed 108B. This prevents visible light 122 from reaching the camera module 110, while allowing background IR 124 and illumination IR 126 to reach the camera module 110.

In another embodiment of the disclosure, a sensor with a filter pattern may be used to reduce motion artifacts. For example with a 2×2 pixel cluster, a filter may be constructed such that (0,0), (0,1) and (1,0) have visible band pass and (1,1) is an IR band pass, with the pattern repeated across the sensor array. In the exposure with no IR, the three pixels sensitive to visible light optimally sample the scene, with the IR sampling the background. The next frame is optimized for IR, and the 4^{th} pixel is used with the previous frame's IR to remove backgrounds following the scaling principle outlined above. This further increases the signal-to-noise ratio.

In another embodiment of the disclosure, the motion artifacts may be fully removed by the inclusion of an optical shutter (for example a liquid crystal) placed between the incoming light and the sensor. The optical shutter in FIG. 2 is set up in front of the camera module. An alternative configuration integrates the shutter into the camera module, placing it between the last element of the lens and the sensor.

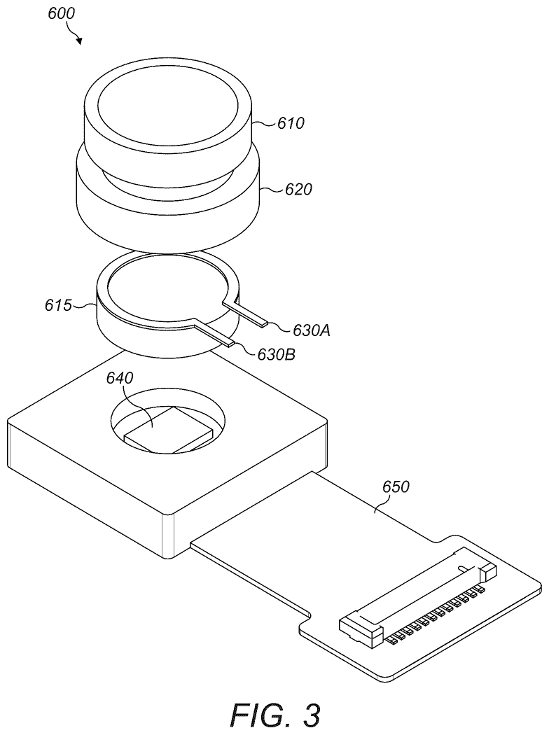

Turning to FIG. 3, shown is a schematic 600 shows an optional optimization which integrates the LC into the camera module between the lens and the sensor, reducing the size of the unit. A lens 610 is held by a lens holder 620 and is seated above an integrated liquid crystal 615 and then above a sensor 640. Electrodes 630A and 630B and circuity 650 interface with the device. This solution has the advantage of requiring a smaller area for the liquid crystal.

The optical shutter in FIGS. 2 and 3 has two states, open and closed. In the open state, visible and IR light pass through. In the closed state, visible light is blocked and IR light passes through. These states are synchronized with the context running on the sensor. Thus, in context 1, the shutter is open, and in context 2, the shutter is closed.

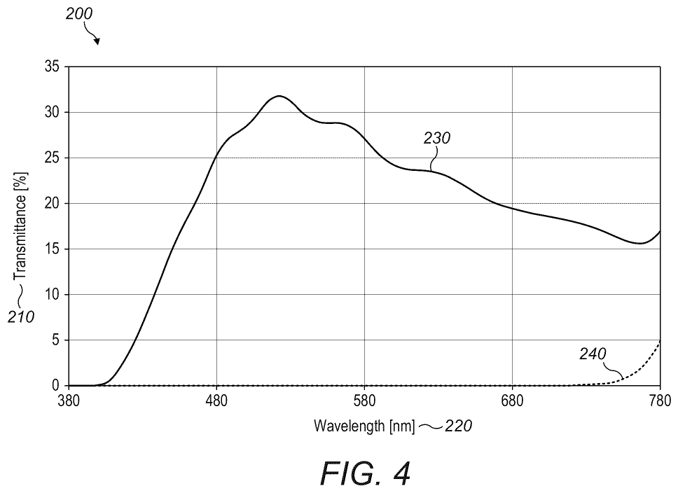

Turning to FIG. 4, shown is a graph 200 with the wavelength in nm on the x-axis 220 and the LC transmittance in % on the y-axis 210. The solid line 230 plots results when the shutter is open, and the dashed line 240 plots results when the shutter is closed. It can be seen that when the shutter is closed transmittance for background wavelengths 380-700 nm (visible) is close to 0%. But IR (850-940 nm) (not shown) passes through at close to 100% transmittance.

In FIG. 4, the transmission curve of the LC-Tec X-FOS(2) optical shutter shows that in the closed state the wavelengths 400-650 nm corresponding to a visible band on the camera filter is 0%. Although 850 nm is not shown, the trend to higher transmission can be seen in the dashed lines 240 starting at 730 nm, showing in the closed state that IR light still reaches the sensor.

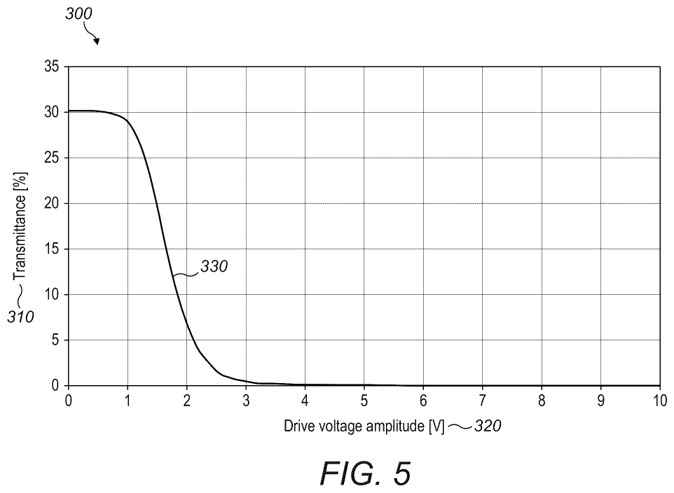

The level of transmission in the closed state is also dependent on the bias voltage and may be optimized according to application requirements of image quality and system power. Turning to FIG. 5, shown is a graph 300 with the drive voltage amplitude on the x-axis 320 and the LC transmittance in % on the y-axis 310. The solid line 330 shows results with visible light (380-700 nm).

The effect of voltage for the X-FOS(2) series of optical shutters shown in FIG. 5 demonstrates that at low voltage (3-4V), the transmittance in the closed state is approaching 0%. This ensures the system (including driver circuity) may be designed to consume little power.

To ensure synchronization between the sensors, IR system, and LC shutter, an LED may be pulsed during the sensor exposure in context 2 when the LC shutter is in the correct state. Imaging sensors may provide a strobe signal that allows external devices to synchronize to the exposure. The strobe may be used to start the LED pulse and LC shutter transition directly if the timing characteristics of the two systems are the same. In systems where this is not the case, the strobe may be used as a trigger to generate the correct waveform for the LED pulse and LC shutter transition using an additional circuit, for instance a microcontroller or FPGA. All the foregoing may be done via a synchronization circuit.

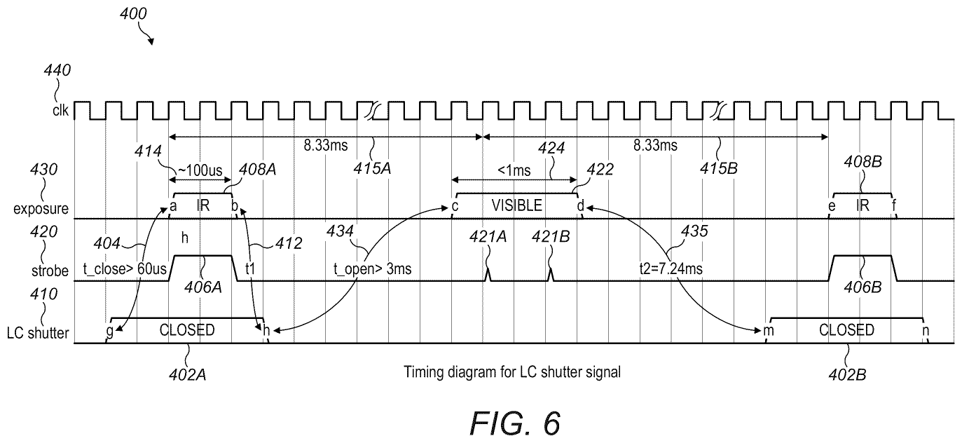

Turning to FIG. 6, shown is a timing diagram 400 for an LC shutter signal. A clock (clk) signal 440 provides timing for cycles 415A 415B lasting 8.33 ms (120 Hz). The exposure row 430 shows that every 8.33 ms, the sensors record a new frame alternating between IR 408A 408B and visible light 422. The strobe row 420 and LC shutter row 410 shows the signal activates the IR LED driver 406A 406B only when the liquid crystal shutter is closed (IR frame) 402A 402B. Short strobes 421A 421B may occur during the visible exposure period 422.

The timing diagram 400 further shows that:
the time g-a 404 from the closing of the LC shutter 402A to the beginning of the IR exposure 408A is greater than 60 μs;
the time a-b 414 of the IR exposure 408A is approximately 100 μs;
the time t1 b-h 412 from the end of the IR exposure 408A to the end of the closing of the LC shutter 402A is of short duration;
the time h-c 434 from the opening of the LC shutter to the beginning of the visible light exposure is greater than 3 ms;
the time c-d 424 of the visible light exposure 422 is less than 1 ms;
the time t2 d-m 435 from the end of the visible light exposure 422 to the beginning of the closing of the LC shutter 402B is 7.24 ms;
the LC shutter 402B closing time m-n mirrors the LC shutter 402A closing time g-h; and
the IR exposure time 408B e-f mirrors the IR exposure time 408A a-b.

FIG. 6 thus is a timing diagram 400 showing the signals used to trigger the opening/closing of the LC shutter with respect to the camera strobe signal. A dedicated timing synchronization circuit ensures that the timing is compatible with the specifications of the liquid crystal. Characteristic timing to open and close the shutter depend on the specific liquid crystal units. Every 8.3 ms (120 Hz) the sensors record a new frame, alternating between visible and IR. The strobe signal activates the IR LED driver only when the liquid crystal shutter is closed (IR frame). During the visible frame recording, the LEDs are off and the shutter is open.

FIG. 6 thus shows a waveform where the strobe is used to drive the LED pulse and a FPGA is used to generate the waveform for the LC shutter. In this diagram, the LC shutter and strobe are synchronized with exposure in context 2. These signals change such that the shutter state is open and the strobe is low so the IR illumination is not active for the exposure in context 1. The timing of this sequence is important to allow high frame rates to be achieved, the example FIG. 6 shows the system operating at 120 fps.

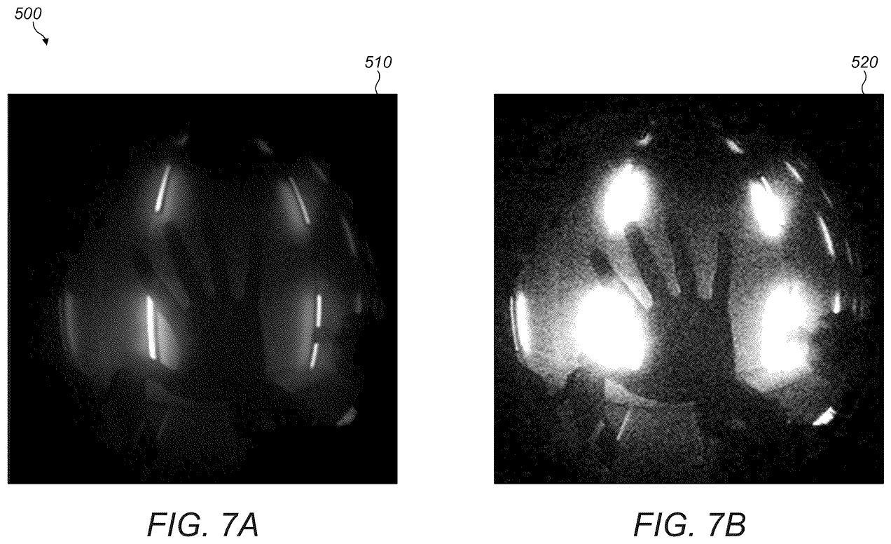

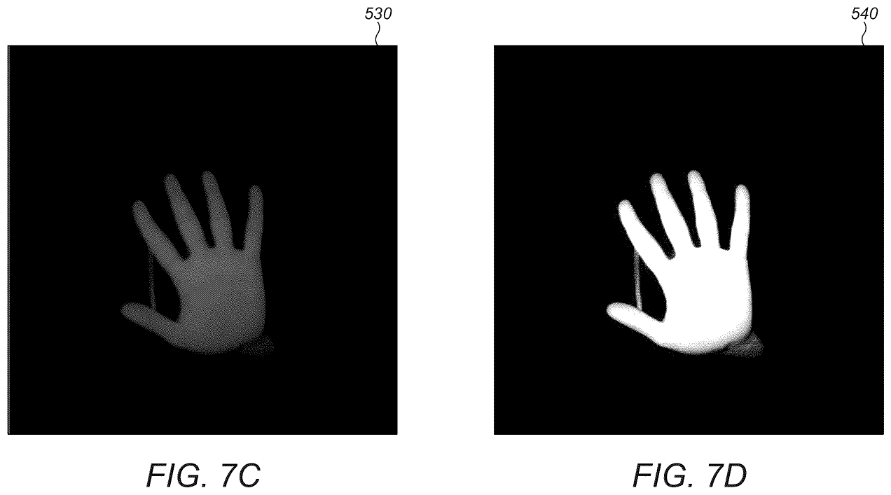

Turning to FIGS. 7A through 7D, shown is a sequence 500 of images illustrating the foregoing. FIG. 7A shows a frame 510 taken with visible ambient light. FIG. 7B is a high contrast image 520 of FIG. 7A. FIG. 7C shows a subsequent frame 530 taken with IR illumination. FIG. 7D shows a high contrast image 540 of FIG. 7C.

In FIGS. 7A and 7B, the images 510 520 were produced with the shutter in the open state. The overhead lighting is clearly seen in the background while the hand in the foreground is very dim. In FIGS. 7C and 7D, the images 530 540 were produced with the shutter in the closed state with the IR active. Here, the hand in the foreground is clearly seen while the background is dark. These images may form the two input feeds for SLAM and hand-tracking, respectively.

Throughout this disclosure, a distinguisher may be used for distinguishing between foreground objects and background objects.

Another embodiment may be to use IR sources that are either always on or switchable using optoelectrical parts, which can be synchronized using principles described above. “Always on” sources may either directly, or by means of refocusing background IR, illuminate the near field in the hand tracking volume. As such, far field features would still be within the dynamic range of the sensor. In this instance, IR would be present in the frames used for SLAM and would extend the feature space to include those present in the near field under IR. This would not cause any detriment to the SLAM performance. In the hand tracking frame the visible background is removed using techniques described above.

This disclosure may be further expanded by introducing a third context used for other IR devices, such as controllers. In this case, the controller is emitting IR that needs to synchronized to the exposure and the LC shutter. This would enable another AE to optimize images for that application. In the case where hand and controller tracking are tightly coupled, a single context may be shared where lighting is optimized for both inputs.

In another embodiment, the IR light source linearly polarizes so that specular reflections from background objects in the scene are minimized. This ensures the objects of interest are the brightest in the scene. For this to be effective, the camera has to have a linear polarizer in the opposite state to be integrated into the fast optical shutter or a standalone filter.

A further embodiment may use a high dynamic range sensor, where multiple gains/exposures are taken of a scene in a single frame. In the case of three setting per frame, these may be classified as high, medium and low sensitivity, each occupying a different part of the dynamic range of the sensor. In IR illumination, the high sensitivity component will contain the scene information required for IR tracking. Visible scene information is contained in the medium and low sensitivity parts of the HDR image. This has the added advantage that only a single image is required for both applications. In principle, this would allow the application to run at higher frame rates.

Potential areas of novelty include:
Remove the need for dedicated cameras for IR and visible light: the same sensors can be used for both.
Take advantage of onboard processing to perform background subtraction, increasing signal-to-noise ratio for the IR images.
Use sensor filter patterns to further optimize signal-to-noise for IR images.
Utilize LC material's unique transmission curve to switch on/off the visible spectrum of the incoming light whilst maintaining sensitivity to IR.
LC technology is inherently fast so it may have high frame rates allowing independent systems to use the same imaging hardware.
Changing what spectrum the sensor is subjected to could be achieved with optoelectrical materials where bandpass is tuneable by the application of voltage or current, for instance metamaterials with optical properties that change in the presence of an electric field.
Other materials with optomechanical properties which under stress change optical properties could also be used to accomplish the above.
Enable hardware to be effectively shared between tracking modalities, principally SLAM, hand tracking and controller tracking.

CONCLUSION

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A system comprising:
a camera module having an optical shutter and connected to a synchronization circuit;
wherein when the optical shutter is open, visible light and infrared light can reach the camera module;
wherein when the optical shutter is closed, visible light cannot reach the camera module and infrared light can reach the camera module.

2. The system as in claim 1, wherein the infrared light is pulsed.

3. The system as in claim 1, wherein the infrared light is flooded.

4. The system as in claim 1, further comprising:
a distinguisher for distinguishing between foreground objects and background objects.

5. The system as in claim 2, further comprising:
a distinguisher for distinguishing between foreground objects and background objects.

6. The system as in claim 3, further comprising:
a distinguisher for distinguishing between foreground objects and background objects.

7. The system as in claim 1, further comprising a first context that receives ambient light frames that are used for processing.

8. The system as in claim 7, wherein the processing includes simultaneous localization and mapping.

9. The system as in claim 7, further comprising a second context that distinguishes foreground objects from background objects.

10. The system as in claim 9, wherein at least one of the foreground objects is tracked.

11. The system as in claim 10, wherein the at least one of the foreground objects is a hand.

12. A system comprising:
a camera module having a liquid crystal optical shutter and connected to a synchronization circuit and a processing circuit;
wherein when the liquid crystal optical shutter is open, visible light and infrared light can reach the camera module, and the processing circuit performs computer vision on the visible light and infrared light to produce a first image;
wherein when the liquid crystal optical shutter is closed, visible light cannot reach the camera module and infrared light can reach the camera module, and the processing circuit performs object tracking on the infrared light to produce a second image.

13. The system as in claim 12, wherein the synchronization circuit conducts synchronization of the infrared light with the liquid crystal optical shutter.

14. The system as in claim 13, wherein the first image has first image information;
wherein the second image has second image information;
and wherein the processing circuit subtracts the second image information from the first image information.

15. The system as in claim 14, wherein the liquid crystal optical shutter is integrated into the camera module.

16. The system as in claim 14, further comprising an infrared light source directed to objects outside the camera module where some infrared light from the infrared light source is reflected from outside the camera module into the camera module.

17. The system as in claim 16, wherein the infrared light source produces linearly polarized infrared light.

18. The system as in claim 14, further comprising a distinguisher that distinguishes foreground objects from background objects.

19. The system as in claim 18, wherein at least one of the foreground objects is tracked.

20. The system as in claim 19, wherein the at least one of the foreground objects is a hand.
